(19) United States
(12) Patent Application Publication
(10) Pub. No.: US 2019/0241058 A1
(43) Pub. Date: Aug. 8, 2019

(54) HYDRAULIC CIRCUIT FOR A HYBRID DRIVETRAIN

(71) Applicant: SCHAEFFLER TECHNOLOGIES AG & CO. KG, HERZOGENAURACH (DE)

(72) Inventors: Marco GRETHEL, Buehlertal (DE); Yunfan WEI, Buehl (DE); Andre SCHAUER, Buehl (DE)

(73) Assignee: SCHAEFFLER TECHNOLOGIES AG & CO. KG, HERZOGENAURACH (DE)

(21) Appl. No.: 16/326,054

(22) PCT Filed: Sep. 27, 2017
(86) PCT No.: PCT/DE2017/100824

§ 371 Date: Feb. 15, 2019

(30) Foreign Application Priority Data
Oct. 25, 2016 (DE) 10 2016 220 964.7

(51) Int. Cl. B60K 6/448; B60K 26/04; F16H 61/00

(52) U.S. Cl. CPC B60K 6/448; F15B 21/00; F16H 61/0021; B60K 26/04

(57) ABSTRACT

A hydraulic circuit for a hybrid drive train for changing driving operation states of a hybrid-operated vehicle, comprising a first fluid flow source including a first pump actuator, a second fluid flow source featuring a second pump actuator, a first shuttle valve arranged between the first pump actuator and the second pump actuator, a first clutch and a second clutch that are fluidically connected to the first shuttle valve so that the first clutch and the second clutch can respectively be fluidically controlled via the first pump actuator or the second pump actuator, a third clutch configured to be fluidically controlled at least via the first pump actuator, and a fourth clutch configured to be fluidically controlled at least via the second pump actuator.

### CROSS-REFERENCE TO RELATED APPLICATIONS

This application is the U.S. National Phase of PCT/DE2017/100824 filed Sep. 27, 2017, which claims priority to DE 102016220964.7 filed Oct. 25, 2016, the entire disclosures of which are incorporated by reference herein.

### TECHNICAL FIELD

The disclosure relates to a hydraulic circuit for a hybrid drive train for changing driving operating states of a hybrid-powered motor vehicle and a motor vehicle with a hybrid engine, comprising a hydraulic circuit.

### BACKGROUND

Motor vehicle transmissions generally feature clutches and/or brakes in order to exert a frictional connection onto a clutch disc. The respective clutches and/or brakes of the motor vehicle transmission are usually individually supplied with energy for actuating via hydraulic pumps that are centrally driven by the internal combustion engine, wherein each respective clutch or brake is assigned to one electrohydraulic control element.

Another alternative is presented by an activation of the clutches and/or brakes by a respectively assigned electric motor. The coupling between the electric motor and the clutches or brakes is carried out either in a purely mechanical manner or combined in a mechanical/hydrostatical manner. The greatest potential for reducing the actuating energy is found here, since the actuating energy is supplied in a direct way to the clutches and/or brakes as the need may be. However, the required installation space for this is relatively large.

There is a continuing need to optimize the hydraulic circuit for a hybrid drive train in order to reduce costs, installation space, and the energy consumption for the actuation.

### SUMMARY

It is an objective of the disclosure to provide a hydraulic circuit for a hybrid drive train in order to change driving operating states of a hybrid-powered vehicle, which features a reduced installation space, which can be manufactured in an economically efficient way and which features an energy consumption for the operation of the clutches or brakes that is reduced to a minimum.

The solution of the task is accomplished in line with the disclosure by using a hydraulic circuit and a motor vehicle comprising a hybrid drive as disclosed below. Other embodiments are described below, which can present one respective aspect of the disclosure, either individually or in a combination.

In line with the disclosure, a hydraulic circuit for a hybrid drive train for changing driving operation states of a hybrid-operated vehicle is provided, comprising a first fluid flow source featuring a reversible first pump actuator, a second fluid flow source featuring a reversible second pump actuator, at least four fluidically actively actuatable actuation devices for changing the driving operation states, wherein a first shuttle valve is arranged between the first pump actuator and the second pump actuator, and the first actuation device and the second actuation device are fluidically connected to the first shuttle valve, so that the first actuation device and the second actuation device can respectively be fluidically controlled via the first pump actuator and/or the second pump actuator, wherein one respective control valve is installed upstream of the first actuation device and/or of the second actuation device, and the third actuation device can be fluidically controlled at least via the first pump actuator and the fourth actuation device can be fluidically controlled at least via the second pump actuator.

A hybrid powered motor vehicle may be understood to be a motor vehicle that features as its drive at least one internal combustion engine and at least one electromotive drive.

A driving state of the hybrid-powered motor vehicle may be understood to be a first driving operation state with one or more transmission stages of an internal combustion engine. A second driving operation state preferably features one or more transmission stages for a purely electric drive of the motor vehicle. A third driving operation state preferably comprises one or more interconnections for an operation of the motor vehicle with electronically controlled continuously variable transmission functions (e-CVT). A fourth driving operation state—a charging state when standing, in which the internal combustion engine preferably powers an electric drive when the motor vehicle is not moving and while the internal combustion engine is running in order to generate electricity and wherein the generated energy is saved in a storage arrangement in order to supply power to the electric drive.

The term actuation device may be understood to be a clutch and/or a brake that is used to carry out a frictional connection with a friction partner which is rotating around a drive shaft within a transmission, wherein the respective clutch and/or brake can be fluidically controlled and can thus be axially moved in order to engage and/or disengage the frictional connection. The clutch and/or brake can be “normally open” or “normally closed”. The expression “normally open” is to be understood in that the clutch and/or brake is not set in a frictional connection in the initial state. Only a hydraulic or fluidical pressure that is exerted onto the clutch and/or brake will produce a frictional connection of the clutch and/or brake with the respective friction partner. This is accordingly reversed in a “normally closed” clutch and/or brake. The clutch may refer to a dry and/or wet clutch and the brake may correspondingly refer to a dry and/or wet brake. In like manner, the actuation device may be a combined clutch/brake, which may be a dry and/or wet clutch/brake. Further actuation devices other than clutches and/or brakes are not necessary to carry out the transmission functions and thus also do not have to be actuated, i.e. a hydraulic or fluidical pressure does not have to be applied. Transmissions whose actuation devices feature clutches and/or brakes, are typically made with planetary gear sets.

The hydraulic circuit thus comprises a first fluid flow source and a second fluid flow source that is different from the first fluid flow source. The first fluid flow source comprises a reversible first pump actuator, and the second fluid flow source comprises a reversible second pump actuator. A pump actuator may be understood as a hydraulic pump. Reversible means that the pump actuator or the hydraulic pump can be operated in two directions. Four actuation devices for changing the driving operation states can be fluidically controlled by the first pump actuator and/or the second pump actuator. A first shuttle valve is arranged between the first pump actuator and the second pump actuator, wherein the first actuation device and the second actuation device of the four actuation devices are fluidically connected to the first shuttle valve, so that the first actuation device and the second actuation device can be hydraulically actuated respectively via the first pump actuator or via the second pump actuator. A shuttle valve is also known under the term “OR valve”. One respective control valve is installed upstream of the first actuation device and of the second actuation device, by using the inflow to the first actuation device or to the second actuation device can be controlled. The third actuation device can be fluidically or hydraulically controlled via the first pump actuator and the fourth actuation device can be fluidically or hydraulically controlled via the second pump actuator. In this way it is possible to fluidically control the four actuation devices in order to change the driving operation states in dependence of the rotation direction of the first pump actuator and of the second pump actuator, wherein it is not necessary to actuate more than two of the four actuation devices via the first pump actuator and/or via the second pump actuator in order to change a driving operation state. Thus, a hydraulic circuit for a hybrid drive train for changing driving operation states is presented, wherein the driving operation states can be changed by using only two pump actuators, so that it is possible to reduce installation space, costs and energy consumption.

Another further development of the disclosure is that the first pump actuator and the second pump actuator feature a respective first pump outlet and a second pump outlet, wherein the first shuttle valve is arranged between the first pump outlet of the first pump actuator and the first pump outlet of the second pump actuator. The first actuation device and the second actuation device are connected via a third outlet of the first shuttle valve.

Another further development of the disclosure is found in that the first pump outlet and the second pump outlet of the first pump actuator are fluidically connected to each other via a first two pressure valve and/or the first pump outlet and the second pump outlet of the second pump actuator are connected to each other via a second two pressure valve. In this context, another development of the disclosure stipulates that the first two pressure valve and/or the second two pressure valve feature a respective third outlet for connecting to a reservoir. A two pressure valve may be understood to be a two pressure valve with two inlet ports, one outlet port and a movable switching piston that is designed in a dumbbell-shape, wherein the inlet port can be moved between the two inlet ports and the switching piston in such a way, that one inlet port is opened and the other one is closed, wherein the outlet port is always open.

In an alternative development of the disclosure it is intended that the first pump actuator can be driven via the first electric motor and/or the second pump actuator can be driven via a second electric motor. The first electric motor and/or the second electric motor may be reversible. In this way the first pump actuator and the second pump actuator can be operated by one respective electric motor, by which it is possible to reduce costs, installation space and energy consumption of the hydraulic circuit.

According to another development of the disclosure it is intended that the first pump actuator is communication-technically connected to a first control unit and/or the pump actuator to a second control unit. The first control unit and the second control unit may be one respective local control unit (LCU). In this way, it is possible to drive the first pump actuator and/or the second pump actuator or the respective electric motor of the first pump actuator and of the second pump actuator in a simple way. It may be intended in particular that the first pump actuator and the second pump actuator can be driven via only one control unit. In this way it is possible to reduce costs, installation space and energy consumption of the hydraulic circuit.

An advantageous further development of the disclosure is found in that the second pump outlet of the first pump actuator and the second pump outlet of the second pump actuator are fluidically connected to each other via a second two pressure valve, and the third actuation device and the fourth actuation device are fluidically connected to the second shuttle valve, so that the third actuation device and the fourth actuation device can respectively be fluidically controlled by the first pump actuator and/or the second pump actuator, wherein one respective control valve is connected upstream of the third actuation device and/or the fourth actuation device. In this way, each one of the four actuation devices can be fluidically or hydraulically controlled by the first pump actuator or the second pump actuator, so that the transitions between the changes of the driving operating states can be optimized by an increased functional availability of the actuation devices.

According to an advantageous further development of the disclosure, it is intended that the control valve that is placed upstream of the respective actuation device is a 2/2-way valve and/or a 3/3-way valve. If the control valve is a 2/2-way valve, hydraulic fluid may be supplied to the respective actuation device and hydraulic pressure can thus be built up or hydraulic fluid can be returned from the actuation device and hydraulic pressure can thus be reduced. In the case of a 3/3-way valve, there is also the possibility that hydraulic fluid for reducing the hydraulic pressure can be led back into a reservoir independently of the first pump actuator and/or of the second pump actuator. In this way, the transitions between the driving operation states can be accelerated.

Another development of the disclosure is that the control valve can be controlled electromechanically. In this way, each control valve can be individually activated in an electromechanical way, allowing for a fast and robust control of the respective actuation device in order to change the driving operation state.

The disclosure furthermore relates to a motor vehicle with a hydraulic drive, comprising a hydraulic circuit for a hybrid drive train to switch from driving operating states of a hybrid-powered motor vehicle, comprising a first fluid flow source having a reversible first pump actuator, a second fluid flow source having a reversible second pump actuator, at least four fluidically actively actuatable actuation devices for changing the driving operation states, wherein a first shuttle valve is arranged between the first pump actuator and the second pump actuator, and the first actuation device and the second actuation device are fluidically connected to the first shuttle valve, so that the first actuation device and the second actuation device can respectively be fluidically controlled by the first pump actuator and/or the second pump actuator, wherein one respective control valve is installed upstream of the first actuation device and/or of the second actuation device, and the third actuation device can be fluidically controlled at least via the first pump actuator and the fourth actuation device can be fluidically controlled at least via the second pump actuator.

### BRIEF DESCRIPTION OF THE DRAWINGS

In the following, the disclosure will be described by means of illustrations with reference to the attached drawings based on embodiments, wherein the characteristics that are depicted in the following may represent an aspect of the disclosure both individually as well as in combination. The drawings show:

FIG. 1 a schematic representation of a hydraulic circuit according to a first embodiment of the disclosure,

FIG. 2 a schematic representation of a hydraulic circuit according to a second embodiment of the disclosure,

FIG. 3 a schematic representation of a hydraulic circuit according to a third embodiment of the disclosure.

### DETAILED DESCRIPTION

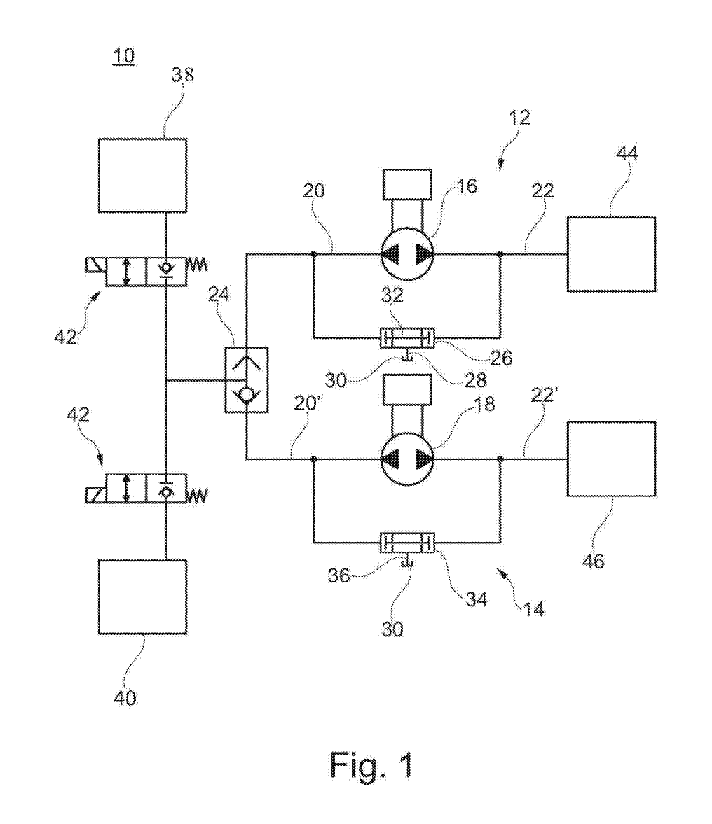

In FIG. 1, a schematic representation of a hydraulic circuit 10 for a hybrid drive train to switch from driving operating states of a hybrid-powered motor vehicle is shown. A driving state of the hybrid-powered motor vehicle may be understood to be a first driving operation state with one or more transmission stages of an internal combustion engine. A second driving operation state may feature one or more transmission stages for a purely electric drive of the motor vehicle. A third driving operation state comprises one or more interconnections for an operation of the motor vehicle with an electronically controlled continuously variable transmission (e-CVT). A fourth driving operation state—a charging state when standing, in which the internal combustion engine may propel an electric drive when the motor vehicle is not moving and while the internal combustion engine is running in order to generate electricity and wherein the generated energy is saved in a storage arrangement in order to supply power to the electric drive.

The hydraulic circuit 10 comprises a first fluid flow source 12 and a second fluid flow source 14 that is different from the first fluid flow source 12. The first fluid flow source 12 comprises a reversible first pump actuator 16, and the second fluid flow source 14 comprises a reversible second pump actuator 18. A pump actuator 16, 18 is to be understood as a hydraulic pump. The hydraulic pump can be operated in two directions.

The first pump actuator 16 and the second pump actuator 18 feature a respective first pump outlet (20, 20′) and a second pump outlet (22, 22′), wherein a first shuttle valve 24 is arranged between the first pump outlet 20 of the first pump actuator 16 and the first pump outlet 20′ of the second pump actuator.

The first pump outlet 20 of the first pump actuator 16 and the second pump outlet 22 of the first pump actuator 16 are fluidically connected to each other via a first two pressure valve 26, which features two inlet ports, wherein the first two pressure valve 26 comprises a further third outlet 28 that is connected to a reservoir 30 which is filled with a fluid. A two pressure valve 26 is thus understood to be a two pressure valve featuring two inlet ports, one outlet port and a dumbbell-shaped switching piston 32, wherein one inlet port of the first two pressure valve 26 is closed and the other one is opened depending on the position of the switching piston 32. In this way, hydraulic fluid can be supplied from the reservoir 30 via the respectively opened inlet port to the first pump actuator 16 either via the first pump outlet or via the second pump outlet. Thus, the first fluid flow source 12 is provided. A two pressure valve is also known by the term AND valve.

In like manner, the first pump outlet 20′ of the second pump actuator 18 and the second pump outlet 22′ of the second pump actuator 18 are fluidically connected to each other via a second two pressure valve 34 which features two inlet ports, wherein the second two pressure valve 34 comprises a third outlet 36 that is connected to a reservoir 30 which is filled with a fluid.

Thus, hydraulic fluid can be supplied from the reservoir 30 via the respectively opened inlet port to the second pump actuator 18 either via the first pump outlet 20′ or via the second pump outlet 22′, by means of which the second fluid flow source 14 is provided.

A first actuation device 38 and a second actuation device 40 are fluidly connected via a third outlet of the first shuttle valve 24, so that the first actuation device 38 and the second actuation device 40 can be controlled fluidically via the first pump actuator 16 or via the second pump actuator 18, depending on the position of the first shuttle valve 24. One respective control valve 42 is installed upstream of the first actuation device 38 and of the second actuation device 40, by which the inflow to the first actuation device 38 or to the second actuation device 40 can be controlled.

A third actuation device 44 is fluidically connected to the second pump outlet 22 of the first pump actuator 16, so that the third actuation device 44 can be fluidically controlled only via the first pump actuator 16.

A fourth actuation device 46 is fluidically connected to the second pump outlet 22′ of the second pump actuator 18, so that the fourth actuation device 46 can be fluidically controlled only via the second pump actuator 18.

The term actuation device 38, 40, 44, 46 is understood to be a clutch and/or a brake that is used to carry out a frictional connection with a friction partner which is rotating around a drive shaft within a transmission, wherein the respective clutch and/or brake can be actuated fluidically and may thus be moved in axial direction. The clutch and/or brake can be “normally open” or “normally closed”. The expression “normally open” is to be understood that the clutch and/or brake is not set in a frictional connection in the initial state. Only a hydraulic or fluidical pressure that is exerted onto the clutch and/or brake produces a frictional connection of the clutch and/or brake with the respective clutch disc. This is accordingly reversed in a “normally closed” clutch and/or brake.

The four actuation devices 38, 40, 44, 46 can be fluidically controlled in order to change the driving operation states in dependence of the rotation direction of the first pump actuator 16 and of the second pump actuator 18, wherein it is not necessary to actuate more than two of the four actuation devices 38, 40, 44, 46 via the first pump actuator 16 and/or via the second pump actuator 18 in order to change a driving operation state. Thus, a hydraulic circuit 10 for a hybrid drive train for changing driving operation states is presented, wherein the driving operation states can be changed by using only two pump actuators 16, 18, so that it is possible to reduce installation space, costs and energy consumption.

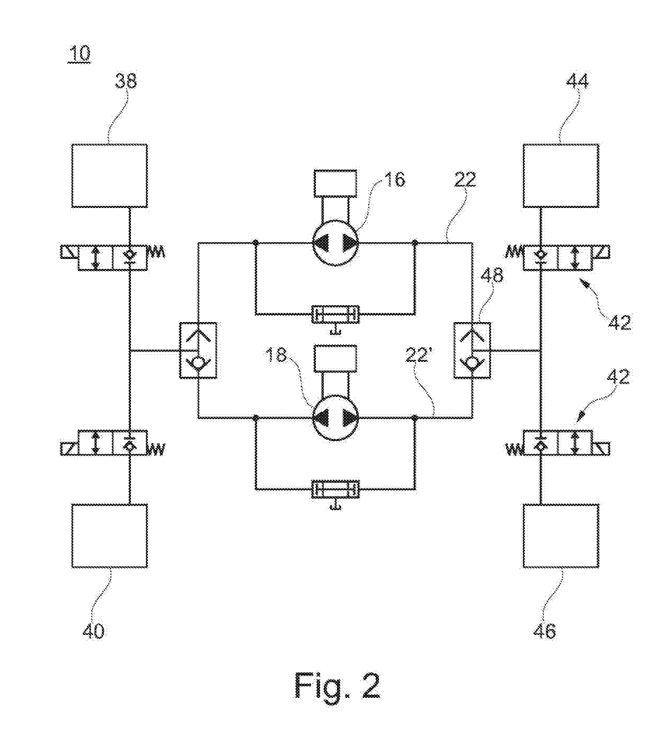

In FIG. 2, the known hydraulic circuit 10 from FIG. 1 is shown, wherein the second pump outlet 22 of the first pump actuator 16 and the second pump outlet 22′ of the second pump actuator 18 are fluidically connected to each other via a second shuttle valve 48. The third actuation device 44 and the fourth actuation device 46 are fluidically connected to the second shuttle valve 48, so that the third actuation device 44 and the fourth actuation device 46 can respectively be fluidically controlled by the first pump actuator 16 and/or the second pump actuator 18. One respective control valve 42 is installed upstream of the third actuation device 44 and of the of the fourth actuation device 46, so that the respective actuating device can be controlled individually. In this way, each one of the four actuation devices 38, 40, 44, 46 can be fluidically or hydraulically controlled by the first pump actuator 16 or the second pump actuator 18, so that the transitions between the changes of the driving operating states can be optimized by an increased functional availability of the actuation devices 38, 40, 44, 46 it is.

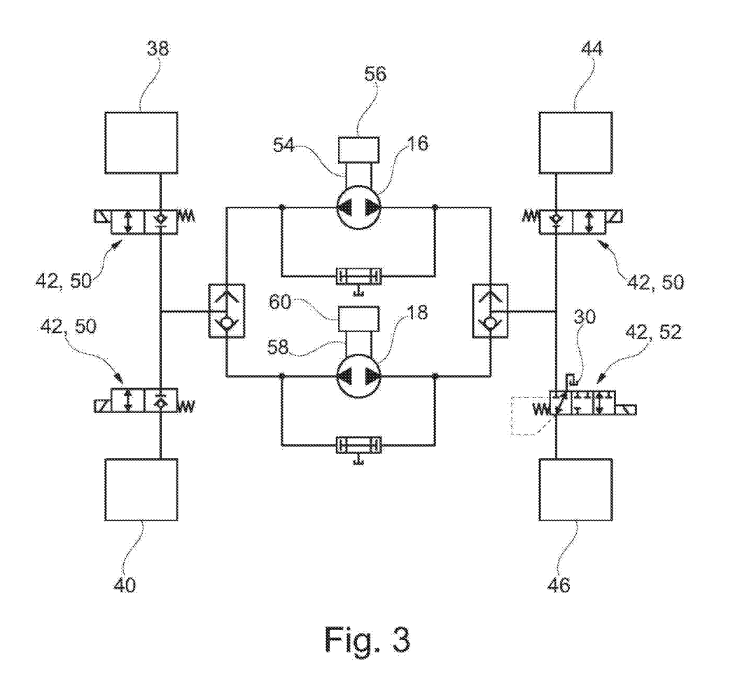

In FIG. 3, the known hydraulic circuit 10 from FIG. 2 is shown, wherein a control valve 42, which is designed as a 2/2-way valve 50 is respectively placed upstream of the first actuation device 38, the second actuation device 40 and the third actuation device 44. One control valve 42, which is designed as a 3/3-way valve 52 is connected upstream of the fourth actuation device 46. In contrast to the 2/2-way valve 50, the 3/3-way valve 52 features an outlet that is fluidically connected to reservoir 30, by which the fourth actuation devices 46 can be hydraulically relieved, independent of the first pump actuator 16 and of the second pump actuator 18, by which the transitions between changes of driving operating states can be accelerated.

The first pump actuator 16 can be controlled via a reversible first electric motor 54. In this way, the first pump actuator 16 can easily be operated in two directions. The first electric motor 54 and the first pump actuator 16 are connected to a first control device 56 and can thus be easily controlled. In like manner, the second pump actuator 18 is connected to a second electric motor 58 and a second control device 60.

### LIST OF REFERENCE SIGNS

10 Hydraulic circuit
12 First fluid flow source
14 Second fluid flow source
16 First pump actuator
18 Second pump actuator
20, 20′ First outlet
22, 22′ Second outlet
24 First shuttle valve
26 First two pressure valve
28 Third outlet (first two pressure valve)
30 Reservoir
32 Switching piston
34 Second two pressure valve
36 Third outlet (second two pressure valve)
38 First actuation device
40 Second actuation device
42 Control valve
44 Third actuation device
46 Fourth actuation device
48 Second shuttle valve
50 2/2-way valve
52 3/3-way valve
54 First electric motor
56 First control unit
58 Second electric motor
60 Second control unit

1. A hydraulic circuit for a hybrid drive train for changing driving condition states of a hybrid-powered motor vehicle comprising:
a first fluid flow source that includes a reversible first pump actuator;
a second fluid flow source that includes a reversible second pump actuator; and
at least four fluidically actively controllable actuation devices for changing the driving condition states, wherein
a first shuttle valve is arranged between the first pump actuator and the second pump actuator and a first actuation device and a second actuation device are fluidically connected to the first shuttle valve, so that the first actuation device and the second actuation device can respectively be fluidically controlled via the first pump actuator or the second pump actuator, wherein one respective control valve is installed upstream of the first actuation device or of the second actuation device, and a third actuation device is configured to be fluidically controlled at least via the first pump actuator and a fourth actuation device is configured to be fluidically controlled at least via the second pump actuator.

2. The hydraulic circuit of claim 1, wherein the reversible first pump actuator, and the reversible second pump actuator feature a respective first pump outlet and a second pump outlet, wherein a first shuttle valve is arranged between the first pump outlet of the first pump actuator and the first pump outlet of the second pump actuator.

3. The hydraulic circuit of claim 2, wherein the first pump outlet and the second pump outlet of the first pump actuator are fluidically connected to each other via a first two pressure valve or the first pump outlet and the second pump outlet of the second pump actuator are fluidically connected to each other via a second two pressure valve.

4. The hydraulic circuit of claim 3, wherein the first two pressure valve or the second two pressure valve include a respective outlet for connecting to a reservoir.

5. The hydraulic circuit of claim 1, wherein the first pump actuator can be driven via a first electric motor or the second pump actuator can be driven via a second electric motor.

6. The hydraulic circuit of claim 1, wherein the first pump actuator is connected to a first control unit and/or the second pump actuator to a second control unit.

7. The hydraulic circuit of claim 6, wherein the second pump outlet of the first pump actuator and the second pump outlet of the second pump actuator are fluidically connected to each other via a second shuttle valve, and the third actuation device and the fourth actuation device are fluidically connected to the second shuttle valve, so that the third actuation device and the fourth actuation device can respectively be fluidically controlled by the first pump actuator or the second pump actuator, wherein one respective control valve is connected upstream of the third actuation device or the fourth actuation device.

8. The hydraulic circuit of claim 1, wherein the control valve that is placed upstream of the respective actuation device is a 2/2-way valve or a 3/3-way valve.

9. The hydraulic circuit of claim 1, wherein the control valve can be controlled electromechanically.

10. (canceled)

11. A hydraulic circuit for a hybrid drive train for changing driving operation states of a hybrid-operated vehicle, comprising:
a first fluid flow source including a reversible first pump actuator;
a second fluid flow source featuring a reversible second pump actuator;
a first shuttle valve arranged between the reversible first pump actuator and the reversible second pump actuator;
a first actuation device and a second actuation device that are fluidically connected to the first shuttle valve so that the first actuation device and the second actuation device can respectively be fluidically controlled via the reversible first pump actuator or the reversible second pump actuator;
a third actuation device configured to be fluidically controlled at least via the reversible first pump actuator; and
a fourth actuation device configured to be fluidically controlled at least via the reversible second pump actuator.

12. The hydraulic circuit of claim 11, wherein the first, second, third, and fourth actuation devices are configured to change the driving operation states.

13. The hydraulic circuit of claim 11, wherein the hydraulic circuit further includes a control valve installed upstream of the first actuation device.

14. The hydraulic circuit of claim 11, wherein the hydraulic circuit further includes a control valve installed upstream of the second actuation device.

15. The hydraulic circuit of claim 11, wherein the first, second, third, and fourth actuation devices are either a clutch or brake configured to be fluidically controlled and axially moved in order to engage or disengage a frictional connection.

16. The hydraulic circuit of claim 11, wherein the first pump actuator includes a first and second pump outlet, and the second pump actuator includes a third and fourth pump outlet, wherein a first shuttle valve is arranged between the first pump outlet of the first pump actuator and the third pump outlet of the second pump actuator.

17. A hydraulic circuit for a hybrid drive train for changing driving operation states of a hybrid-operated vehicle, comprising:
a first fluid flow source including a first pump actuator;
a second fluid flow source featuring a second pump actuator;
a first shuttle valve arranged between the first pump actuator and the second pump actuator;
a first clutch and a second clutch that are fluidically connected to the first shuttle valve so that the first clutch and the second clutch can respectively be fluidically controlled via the first pump actuator or the second pump actuator;
a third clutch configured to be fluidically controlled at least via the first pump actuator; and
a fourth clutch configured to be fluidically controlled at least via the second pump actuator.

18. The hydraulic circuit of claim 17, wherein the first pump actuator is configured to be driven via a first electric motor.

19. The hydraulic circuit of claim 18, wherein the second pump actuator is configured to be driven via a second electric motor.

20. The hydraulic circuit of claim 17, wherein the operation states of the hybrid-operated vehicle include a first driving operation state with one or more transmission stages of an internal combustion engine.

21. The hydraulic circuit of claim 20, wherein the operation states of the hybrid-operated vehicle include a second driving operation state with one or more transmission stages for a purely electric drive of the hybrid-operated vehicle.
